(19) United States
(12) Patent Application Publication
(10) Pub. No.: US 2016/0301355 A1
(43) Pub. Date: Oct. 13, 2016

(54) SOLAR-CELL PAVER, SYSTEM, AND METHOD OF INSTALLATION

(71) Applicant: Nicholas Rothwell Small, Fort Lauderdale, FL (US)

(72) Inventor: Nicholas Rothwell Small, Fort Lauderdale, FL (US)

(21) Appl. No.: 14/680,170

(22) Filed: Apr. 7, 2015

(51) Int. Cl. H02S 20/21; E01C 17/00; E01C 9/00

(52) U.S. Cl. CPC H02S 20/21; E01C 9/00; E01C 17/00

(57) ABSTRACT

A solar-cell paver, system and method of installing a plurality of solar-cell pavers is disclosed. The solar-cell paver includes a paver body. The paver body defines a cavity which encloses at least one solar-cell. The solar-cell is electronically coupled to at least one terminal. The solar-cell paver body is made of a permeable material that spans a thickness of the paver body. The solar-cell paver includes a light transmitting member disposed above the solar-cell. The light transmitting member is coupled to the paver body in a watertight configuration. The light transmitting member and is made of a transparent material that defines a portion of the upper surface of the solar-cell paver. The solar-cell paving system includes a plurality of solar-cell pavers joined together in an electrical network to form a continuous driving surface of a roadway.

### FIELD OF THE INVENTION

The present invention relates generally to solar energy systems, and, more particularly, relates to a solar-cell paving method and system having a plurality of solar-cell pavers formed as a roadway and operable to collect and transfer solar energy.

### BACKGROUND OF THE INVENTION

It is well known that solar energy is a virtually inexhaustible and universally available renewable power source that can be harnessed, unlike electrical energy generated from fossil fuels. In light of the limited availability of fossil fuels, such as crude oil, and the recognition that such fossil fuels are major factors in global warming, the need to harness solar energy more efficiently and with less destructive energy sources is readily apparent.

Solar energy has long been an attractive alternative energy source to fossil fuel because solar energy is produced using solar-cells, which are relatively not harmful to the environment. Solar cells are semiconductor electric junction devices that harness the radiant energy of sunlight and convert that sunlight into electrical energy. Accordingly, the sun provides limitless quantities of energy for exploitation. As an added advantage, solar-cells do not pose a threat to the environment, as with fossil fuels. Furthermore, technology is rapidly evolving to make solar energy more efficient to capture and distribute. For example, solar-cells may be used individually as light detectors, e.g., in cameras, or to obtain the required values of current and voltage for electric-power generation.

The conversion of sunlight into electric energy in a solar-cell involves three major processes. Initially, sunlight is absorbed in a semiconductor material. During the first process, when the sunlight is absorbed in the semiconductor, a negatively charged electron and positively charged hole are created. The electric junction within the solar-cell separates these electrons and holes from each other after they are created by the light. A known process of forming the electric junction is by the contact of a two semiconductor regions, such as a P-N junction. The P-N junction is an interface at which P-type silicon and N-type silicon make contact with each other. At the point of contact, the negatively charged electrons (N-type) and the positively charged holes (P-type) cancel each other and form a “depletion zone” that acts as a non-conductive barrier.

Next, free positive and negative charges are generated and move to different regions of the solar-cell, creating a voltage difference within the solar-cell. Lastly, separated charges are transferred through electric terminals to an outside application, such as an energy grid, in the form of electric current. The electric current, together with the cell's voltage defines the power (or wattage) that the solar cell can produce.

Solar power is most commonly associated with roof-top or freestanding photovoltaic panels. Photovoltaic cells, however, can also be used in a variety of applications such as pavers for walkways and roads, greatly expanding the available surface area for the absorption of solar energy. Previous attempts to employ photovoltaic cells in pavers have been limited primarily to ground lights in which the paver has an upper transparent surface illuminated by an inner lighting element such as a light-emitting diode (LED). The photovoltaic element powers only the lighting element within an individual paver and is not used to collect solar energy for distribution via a networked electrical conduit for use elsewhere. Other pavers utilize a glass top over the entire surface and are therefore expensive to manufacture and not conducive to being subject to vehicle traffic.

Furthermore, known solar pavers are not configured to support vehicular traffic. For example, some known solar pavers are unable to support the weight of vehicular traffic and must be located either on pedestrian walkways, or in areas adjacent to roadways where vehicles are restricted from traveling. Some known solar pavers also require notches, or recesses that would cause friction when in contact with fast-moving vehicle tires. Such notches or recesses could also result in damage to vehicle tires. And, conversely, continuous contact with vehicle tires over time would degrade the notches and potentially render the solar paver inoperable.

Existing solar pavers also lack the surface traction and drainage capacity necessary to prevent hazardous conditions such as slippery or flooded roadways. Insufficient drainage and misalignment with the pavers—due to weight on top of the paver, an improperly graded surface, or shifting of the ground surface to which the paver is coupled—also leads to the accumulation of water around, on top, or beneath pavers, causing them to become causing another potentially hazardous condition that is also aesthetically unappealing and structurally unsound.

Therefore, a need exists to overcome the problems with the prior art as discussed above.

### SUMMARY OF THE INVENTION

The invention provides a solar-cell paver, system, and method of installation that overcomes the hereinafore-mentioned disadvantages of the heretofore-known devices and methods of this general type and is designed for use in creating a continuous even roadway using the solar-cell pavers that are capable of converting sunlight into electric energy.

With the foregoing and other objects in view, there is provided, in accordance with the invention, a solar-cell paver that includes a paver body (1) with an upper surface, an opposing lower surface opposite the upper surface, and a thickness separating the upper and lower surfaces, (2) that defines a cavity within the paver body and that encloses at least one solar-cell disposed therein which is electronically coupled to at least one terminal, (3) and that is of a permeable material spanning the thickness of the paver body. The solar-cell paver also includes a light transmitting member disposed above the at least one solar-cell, which is coupled to the paver body in a watertight configuration and is of a transparent material defining a portion of the upper surface.

In accordance with a further feature of the present invention, the permeable material is of a ground tire rubber constituent and substantially surrounds a periphery of the light transmitting member.

In accordance with an additional feature of the present invention, the upper surface is substantially planar or has a partition that is of a substantially uniform width. This partition may preferably be of a substantially uniform width that is at least 4 inches.

In accordance with another feature, an embodiment of the present invention includes a watertight liner interposed between the at least one solar-cell and the permeable material of the paver body. In some instances, the watertight liner is of a shape defined by the cavity.

In accordance with an additional feature of the present invention, the paver body is of a uniform thickness.

In accordance with yet another feature, an embodiment of the present invention includes at least two terminals disposed around a periphery of the paver body, with one of the least two terminals operable as a negative and a second of the least two terminals operable as a positive. In other embodiments, the at least two terminals are shaped to fixedly mate and lock with one another.

In accordance with an additional feature, an embodiment of the present invention includes the light transmitting member having an impermeable resilient material or an upper surface with a periphery flanked by the upper surface of the paver body to form an upper surface partition separating the light transmitting member and a periphery of the paver body. Where the upper surface is flanked by the upper surface, the partition may be of a permeable material.

In accordance with another aspect of the present invention, a solar-cell paving system to collect and transfer solar energy is disclosed that includes a plurality of pavers joined together in an electrical network to form a continuous driving surface of a roadway. The plurality of pavers advantageously has a paver body with an upper surface, an opposing lower surface opposite the upper surface, and a thickness separating the upper and lower surfaces. The pavers also define a cavity within the paver body that encloses at least one solar-cell disposed therein and is electronically coupled to at least one terminal. The pavers are also of a permeable material spanning the thickness of the paver body. The solar-cell paving system also includes a light transmitting member coupled to the paver body in a watertight configuration and of a transparent material defining a portion of the upper surface.

In accordance with another feature of the present invention, the continuous driving surface of the roadway is substantially planar or the plurality of pavers are joined together in an array.

In accordance with an additional feature, an embodiment includes the light transmitting member having an upper surface with a periphery flush with the upper surface of the paver body to form an upper surface partition separating the light transmitting member and a periphery of the paver body. Further, the upper surface partition is of the permeable material.

In accordance with yet another feature, one embodiment includes at least one outside application, the at least one outside application operable to receive a quantity of electrical energy from the plurality of pavers.

In accordance with another aspect of the present invention, a method of installing a plurality of solar-cell pavers is disclosed that includes the steps of (1) providing a compact surface, (2) constructing at least one channel in the compact surface (3) providing a plurality of solar-cell pavers within the at least one channel in which the pavers include: (a) a paver body having an upper surface, an opposing lower surface opposite the upper surface, and a thickness separating the upper and lower surfaces, (b) the body defining a cavity within the paver body that encloses at least one solar-cell disposed therein and electronically coupled to at least one terminal, (c) the paver body having a permeable material spanning the thickness of the paver body, and (d) a light transmitting member disposed above the at least one solar-cell that is coupled to the paver body in a watertight configuration and is of a transparent material defining a portion of the upper surface, and (4) joining the plurality of solar-cell pavers together in an electrical network to form a continuous driving surface of a roadway.

Although the invention is illustrated and described herein as embodied in a solar-cell paver and method of installation, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the paver. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a downward-looking perspective view of a solar-cell paver in accordance with an embodiment of the present invention;

FIG. 2 is a cross-sectional fragmentary view of the solar-cell paver of FIG. 1 along section A-A, depicting a permeable material spanning a thickness of a paver body and defining a cavity in accordance with the present invention;

FIG. 3 a cross-sectional view of the solar-cell paver of FIG. 1 along section A-A, depicting a solar-cell encapsulated within the cavity in accordance with the present invention;

FIG. 4 is a top plan view of the solar-cell paver of FIG. 1 in accordance with the present invention;

FIG. 5 is a downward-looking perspective view of the solar-cell paver of FIG. 1;

FIG. 6 is a left-side elevation view of a pair of terminals of the solar-cell paver of FIG. 1 in accordance with the present invention;

FIG. 7 is a rear elevation view of a second pair of terminals of the solar-cell paver of FIG. 1 in accordance with the present invention;

FIG. 8 is perspective view of an exemplary implementation of a solar-cell paving system having a plurality of solar-cell pavers forming a roadway in accordance with an embodiment of the present invention;

FIG. 9 is an enlarged, fragmentary cross-sectional view of a portion of the solar-cell paving system of FIG. 8, illustrating the plurality of solar-cell pavers operable to collect and transfer solar energy in accordance with an embodiment of the present invention;

FIG. 10 is a block diagram of an exemplary implementation of the system of FIG. 8 in accordance with an embodiment of the present invention; and

FIG. 11 is a process flow diagram for illustrating a method of installing a plurality of solar-cell pavers to form a continuous surface of a roadway in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

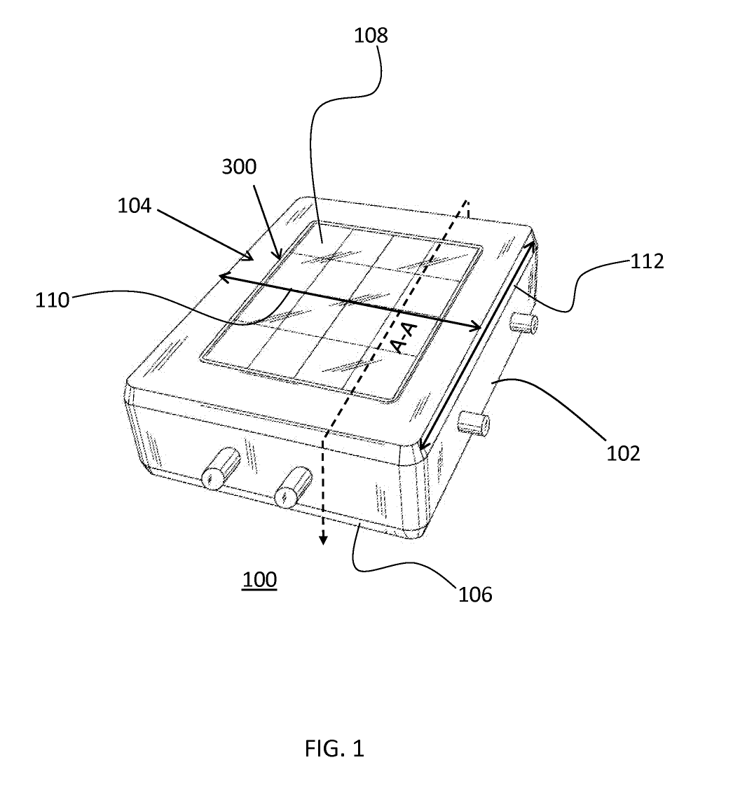

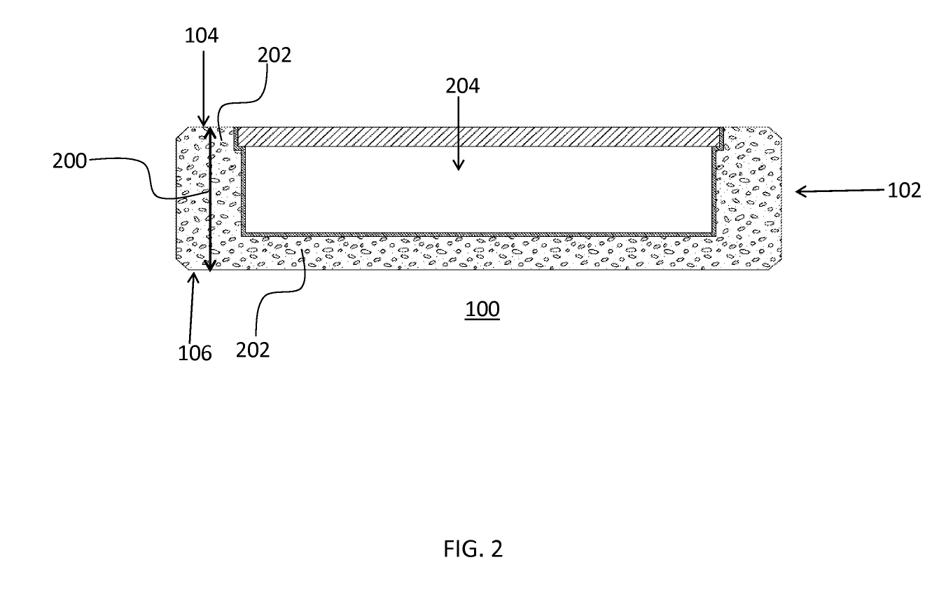

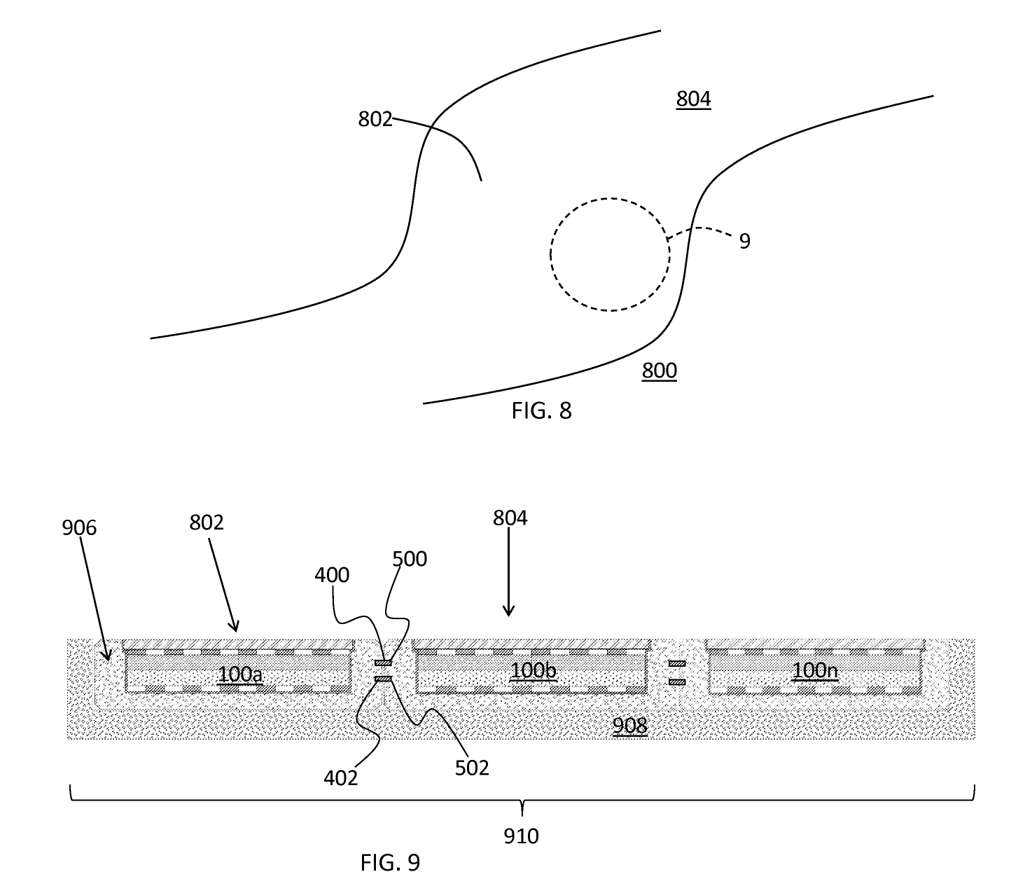

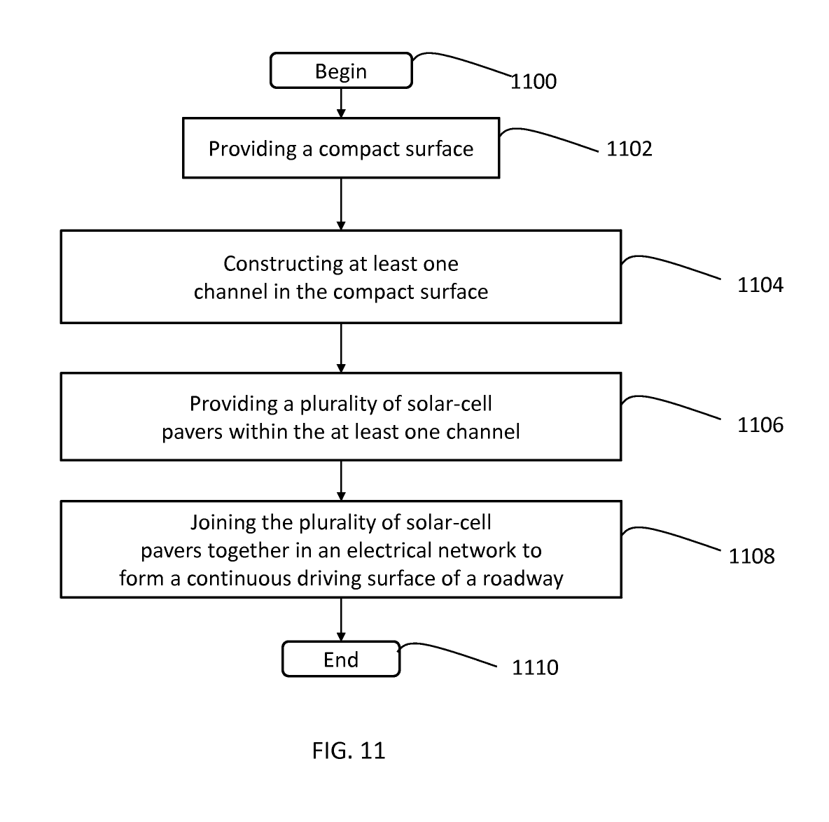

The present invention provides a novel and efficient solar-cell paver 100 (FIG. 1), a solar-cell paving system 800 (FIG. 8), and a method of installing a plurality of solar-cell pavers 100 (FIG. 11) to form a roadway. The solar-cell paver 100 and the solar-cell paving system 800 are designed to collect and transfer the solar energy of sunlight for conversion into electricity that can be used to power nearby devices, homes, businesses, power plants and the like. Embodiments of the invention include the solar-cell paving system 800 having a plurality of solar-cell pavers 100 joined together in an electrical network 910 to form a continuous driving surface 802 of a roadway 804. Advantageously, each solar-cell paver 100 includes a permeable material 202 (FIG. 2) that allows fluid, such as rain, to pass through the paver body, eliminating the need for hazardous drainage crates, while preventing fluid from accumulating within the solar-cell paver 100 typically caused by misalignment of the solar-cell pavers 100 along the roadway 804.

Referring now to FIG. 1, one embodiment of the present invention is shown in a perspective view. FIG. 1 shows several advantageous features of the present invention, but, as will be described below, the invention can be provided in several shapes, sizes, combinations of features and components, and varying numbers and functions of the components. The first example of a solar-cell paver 100, as shown in FIG. 1, includes a paver body 102 having an upper surface 104 and an opposing lower surface 106 that is located opposite from the upper surface 104. The term “paver” is defined herein as a component that forms a surface, such as a floor or a roadway, intended primarily as a support surface for moving bodies. In one embodiment, as depicted in FIG. 1, the upper surface 104 of the paver body 102 is substantially planar. The term “substantially planar” is defined herein as a generally flat, or level surface. Said another way, the surface is flat with no surface height deviation greater than 0.5 inch. In another embodiment, the upper surface 104 may be slightly curved, however it is preferred that the upper surface 104 is substantially planar.

A plurality of solar-cells 108 are encapsulated within the paver body 102. In the exemplary embodiment, the plurality of solar-cells 108 are visible from the upper surface 104 of the solar-cell paver 100. The solar-cells 108 may also be referred to as a photovoltaic cells, as appreciated by one of ordinary skill in the art. The solar-cells 108 are semiconductor electric-junction devices that harness the radiant energy of sunlight. Advantageously, the solar-cells 108 convert the radiant energy into electricity that can be used by electronic devices, electrical components in nearby homes and businesses, and the like. In one embodiment, the solar-cells 108 are made of monocrystalline silicon. In another embodiment, the solar-cells 108 may be made of polycrystalline silicon, multicrystalline silicon, or a similar type of semiconductor material. In one embodiment, the solar-cells 108 may produce an efficiency rate of 12% to 20%. The “efficiency rate” is defined herein as the rate at which the solar-cell converts the solar energy into electricity. In another embodiment, the solar-cell 108 may produce an efficiency rate of greater than 20%.

In a preferred embodiment, the solar-cells 108 include a surface area defined substantially by a width 110 and a length 112 of the upper surface 104 of the paver body 102 for maximum exposure to sunlight. The paver body 102 can encapsulate a plurality of units of solar-cells 108 spanning the width 110 and a plurality of units of solar-cells 108 spanning the length 112. In one embodiment, the paver body 102 can encapsulate two units of solar-cells 108 panning the width 110 and two units of solar-cells 108 spanning the length 112. In another embodiment, a singular solar-cell 108 can be encapsulated by the paver body 102. The number of solar-cells 108 within the paver body 102 may vary, depending on the overall size of the solar-cells 108 and the paver body 102. In one embodiment, the paver body 102 may be approximately 4.0 to 6.0 inches in width and 8.0 to 10.0 inches in length. In another embodiment, the paver body 102 may be 12.0 inches in width and 12.0 inches in length. In other embodiments, the paver body 102 may vary outside of this range. In one embodiment, the paver 100 may be considered “handheld” to permit users to advantageously transport and install pavers quickly and effectively without the use of machinery or special equipment.

The amount of energy generated by each solar-cell paver 100 will vary, depending upon factors such as the number of solar-cells 108 within the solar-cell paver 100, the total surface area of the solar-cells 108 that are exposed to sunlight, the orientation and tilt of the installation of the solar-cells 108, the duration that the solar-cells 108 are exposed to the sunlight, the intensity of the sunlight, and the efficiency rate of the solar-cells 108 to convert sunlight into useable energy. Naturally, the duration of exposure and intensity of the sunlight will vary according to the geographic location of the solar-cell pavers 100 and the season. In one embodiment, the solar-cell pavers 100 may be joined together and electrically coupled together in the electrical network 910 to form the continuous driving surface 802 of the roadway 804 (FIG. 8), e.g., a parking lot. In other embodiments, the solar-call pavers 100 may be joined together and electrically coupled together in the electrical network 910 to form a continuous surface of a sidewalk, a driveway, a basketball court, a tennis court, or another paver surface operable to support moving bodies.

Referring now to FIG. 2, depicting a cross-sectional view of the solar-cell paver 100 along section A-A. FIG. 2 depicts the paver body 102 without the solar-cell 108 embedded within the paver body 102. The upper surface 104 and the lower surface 106 are separated by a thickness 200. In one embodiment, the thickness 200 may be approximately 4.0 to 6.0 inches. In another embodiment, the thickness 200 is slightly greater than a thickness of the solar-cell 108. In other embodiments, the thickness 200 may vary outside of these ranges.

The paver body 102 includes a permeable material 202. In one embodiment, a portion of the permeable material 202 spans across the thickness 200 of the paver body 102. In another embodiment, the thickness 200 of the paver body 102 is uniform from the upper surface 104 to the lower surface 106. Advantageously, the uniform thickness 200 prevents misalignment when installing more than one solar-cell paver 100. For example, with brief reference to FIG. 2 in conjunction with FIG. 8, when installing a plurality of solar-cell pavers 100 to form the roadway 804, the uniform thickness 200 forms a smooth and even surface that is ideal for vehicles traveling over the roadway 804.

As used herein, the term “permeable material” is defined herein as a material operably configured to allow fluid to pass through. The permeable material 202 can include holes or openings that allow fluid, particularly, liquid, such as rain, oil, water, or any other liquid substance, to pass through the paver body 102 from one side thereof to another.

Advantageously, this eliminates the need for hazardous drainage sources, such as drainage grates, that create unsafe roadway conditions for vehicle and pedestrian traffic. Additionally, drainage sources, such as drainage gates, are often aesthetically unappealing. The permeable material 202 also prevents the paver body 102 from becoming misaligned, either horizontally or vertically, due to liquid accumulating around, or beneath the solar-cell paver 100, as is the case with other known solar-cell pavers.

In one embodiment, the permeable material 202 is of a ground tire rubber constituent. The term “constituent” is defined herein as being part of a whole. Advantageously, the ground tire rubber constituent is a friction-inducing material that is slip resistant and shock absorbent while also being firm and stable enough to support moving bodies, making the permeable material 202 ideal for trafficked roadways. In other embodiments, the permeable material 202 is made entirely or substantially entirely of ground tire rubber. Currently, there is a rather large supply of used tire rubber. Recycling used tire rubber into permeable material used for solar-cell pavers 100 in accordance with the present invention is an environmentally conservative use of tire rubber. The permeable material 202 of a material such as ground tire rubber also eliminates the need for a secondary coating to produce friction across the upper surface 104 of the solar-cell paver 100. Advantageously, this reduces the labor and maintenance costs associated with acquiring, applying, and maintaining the secondary coating. Moreover, the permeable material 202 is made of a recycled material, adding to the environmentally conservative nature of the solar-cell paver 100.

As an added advantage, unlike most pavers that require a base of concrete or other hardscape, the permeable material 202 is installed directly on a prepared ground-scape, decreasing the cost of installation and maintenance associated with using the base of concrete or other hardscape. In particular, concrete and other hardscape materials are typically low in tensile strength, requiring use with reinforcement materials, such as steel. Concrete is also subject to cracking and damage by other processes, such as corrosion of steel reinforcement bars, freezing of trapped water, radiant heat damage, bacterial corrosion, and chemical damage from chemical components within rain water and other liquids. The prepared ground-scape may include clay, sand, a combination of clay and sand, soil, or another like material. In one embodiment, the ground-scape is operable to absorb water passing through the permeable material 202 so as to not allow fluid to form pockets around the solar-cell paver 100, causing misalignment of the pavers 100 and the like. The permeable material 202 may be manufactured in various shapes, colors and sizes suitable for various areas such as sidewalks, roadways, driveways, basketball courts, tennis courts, and the like.

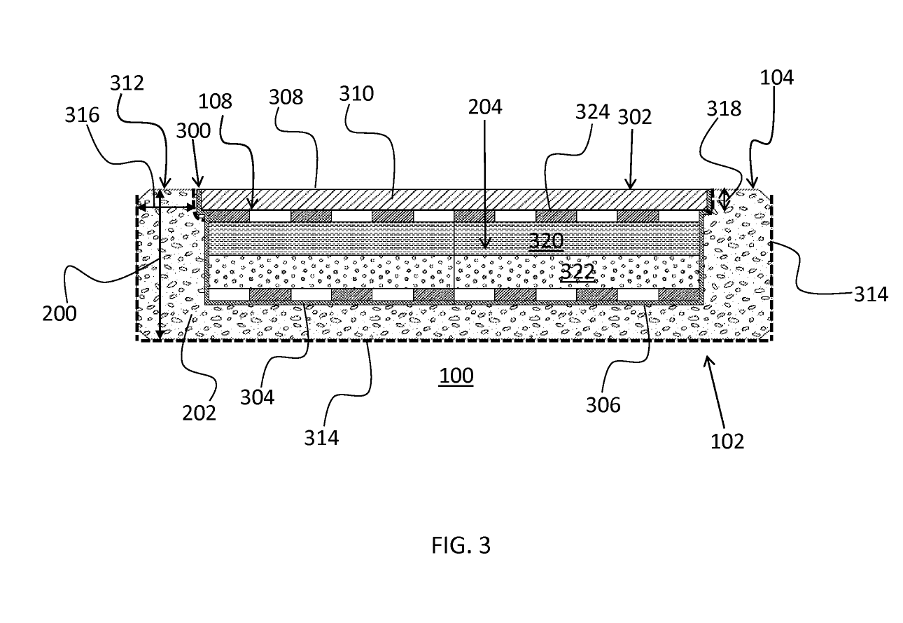

With reference now to FIG. 2 and FIG. 3, the paver body 102 is shown defining a cavity 204 within the paver body 102. Similar to FIG. 2, FIG. 3 is a cross-sectional view of the solar-cell paver 100 along section A-A; however, FIG. 3 depicts the paver body 102 having at least one solar-cell 108 embedded within the cavity 204. In one embodiment, the cavity 204 is shaped and sized to enclose at least one solar-cell 108 disposed therein. In another embodiment, as illustrated in FIG. 3, the cavity 204 may include a pair of solar-cells 108 disposed within the cavity 204. In a further embodiment, the cavity 204 includes a thickness slightly greater than a thickness of the solar-cell 108 to provide a snug fit of the solar-cell 108 within the cavity 204. The solar-cells 108 may be secured within the cavity 204 using screws, bolts, or others fasteners, as appreciated by one of ordinary skill in the art. The overall size of the cavity 204 varies according to the overall size of the paver body 102 and the number of solar-cells 108 that are to be placed within the cavity 204, as determined by an engineer when designing a particular implementation of the solar-cell pavers 100 in accordance with the present invention.

With reference now to FIG. 3, the permeable material 202 substantially surrounds a periphery 300 of a light transmitting member 302 disposed above the solar-cell 108. As used herein, the term “periphery” is intended to indicate an outer limit, or outer edge of an object or area. In one embodiment, the permeable material 202 surrounds a side periphery 300 of the light transmitting member 302, but not an upper and a bottom periphery of the light transmitting member 302, the upper periphery directly interfacing with an external environment and the bottom periphery directly interfacing with the solar-cell 108. “Substantially surrounds,” is defined herein as mostly, but not completely (greater than 85%), surrounding the light transmitting member 302. The light transmitting member 302 provides protection to the solar-cell 108 from external elements, such as environmental elements, and allows the sunlight to reach an upper surface of the solar-cell 108 within the cavity 204. In one embodiment, the light transmitting member 302 may of a width 318 that is approximately 2.0 to approximately 3.0 inches. In another embodiment, the width 318 may be outside of this range.

In one embodiment, the solar-cell 108 includes an N-type silicon layer 320 disposed above a P-type silicon layer 322 and forming a PN-type junction therewith, as is known in the art. An electrical contact grid 324 can be disposed directly above the N-type silicon layer 320 and directly beneath the P-type silicon layer 322, providing an electrically conductive layer for allowing electrical current to flow therethrough, as is known in the art. The electrical contact grid 324 can be made of an electrically conductive metal material, or any other electrically conductive material.

The light transmitting member 302 is coupled to the paver body 102 in a watertight configuration. More specifically, a watertight liner 304 is interposed between the cavity 204 and the permeable material 202 of the paver body 102, so as to prevent liquid from leaking within the cavity 204. The water tight liner 304 is preferably of a polymeric material, such as synthetic rubber, neoprene, silicone, heat-resistant plastic material, or the like, so as to prevent the flow of liquid into the cavity 204 where it may reach the solar-cell 108. The term “liquid” is defined herein as rain, oil, water, or any other fluid substance having a like consistency. FIG. 3 depicts the watertight liner 304 as having a shape defined by an inner surface 306 of the cavity 204. Said another way, the watertight liner 304 is of a material that conforms to the shape of the inner surface 306 of the cavity 204. In another embodiment, the watertight liner 304 may be a pre-formed shape that is measured to fit around the dimensions of the cavity 204. In one embodiment, the watertight liner 304 can be seen as a polymeric sleeve placed within the cavity 204 and form fitted to the shape of the inner surface 306 of the cavity 204. In an alternative embodiment, the watertight liner 304 may be a layer of a fluid-impermeable chemical compound, e.g., closed-cell polyurethane foam, applied, e.g., via a spray, to the inner surface 306 of the cavity 204.

Referring still to FIG. 3, the light transmitting member 302 is shown having an upper surface 308. Advantageously, the light transmitting member 302 includes a transparent material 310 defining a portion of the upper surface 104 of the paver body 102. The transparent material 310 allows the sunlight to reach the solar-cell 108 within the cavity 204. More specifically, in one embodiment, the transparent material 310 is made of an impermeable resilient material designed to allow the sunlight to reach the solar-cell 108, while preventing liquid from entering the cavity 204. As used herein, the term “impermeable” is intended to indicate a material that is operably configured to not allow fluid to pass through. More specifically, the impermeable material is operably configured to not allow liquid to pass through. As used herein, the term “resilient” is intended to indicate a material that is able to recoil or spring back into shape after being compressed. A resilient material may be less susceptible to cracking over time, which may otherwise occur with less resilient materials, such as concrete. In embodiments, the transparent material 310 is made of one of a glass, an acrylic, and a polycarbonate material. The material 310 is preferably configured to be sufficiently durable to sustain the weight of vehicles traveling over the upper surface 308 over time when formed as the roadway 804 (FIG. 8). In some embodiments, the transparent material 310 is of a rigid or semi-rigid material. In yet further embodiments, the transparent material 310 is of a flexible material that may be supported by a more rigid material. In one embodiment, the transparent material 310 may be translucent. In another embodiment, the transparent material 310 may be seen as a clear material. The transparent material 310 may include an anti-glare feature that is operable to prevent a glare from projecting off of the transparent material 310 to distract a driver driving a vehicle across the roadway. In addition, the transparent material 310 may be capable of sustaining the appropriate painted markings associated with roadways.

FIG. 3 shows the upper surface 308 of the light transmitting member 302, with the side periphery 300 of the light transmitting member 302 flanked by the upper surface 104 of the paver body 102 to form an upper surface partition 312. In one embodiment, the upper surface partition 312 separates the periphery 300 of the light transmitting member 302 and a periphery 314 of the paver body 102. In another embodiment, a periphery of the upper surface 308 of the light transmitting member 302 is flush with the upper surface 104 of the paver body 102 to form the upper surface partition 312. In yet another embodiment, the upper surface partition 312 is made of the permeable material 202. In one embodiment, the upper surface partition 312 includes a beveled edge, as depicted in FIG. 3.

In an alternative embodiment, the upper surface partition 312 has a substantially uniform width 316 along the upper surface 104 of the paver body 102. “Substantially uniform,” is defined herein as having a width that is the same along substantially an entire length of a body. Providing a substantially uniform width creates more uniform traction, particularly when solar-cell pavers 100 are coupled together in a system, which further reduces the need for the application of the secondary coating over the upper surface 308. In one embodiment, the width 316 is at least 4.0 inches. In one embodiment, the width 316 is at least 2.0 inches. In yet another embodiment, the width 316 may be less than 4.0 inches. In other embodiments, the width 316 may vary outside of these ranges, depending on the overall size of the paver body 102.

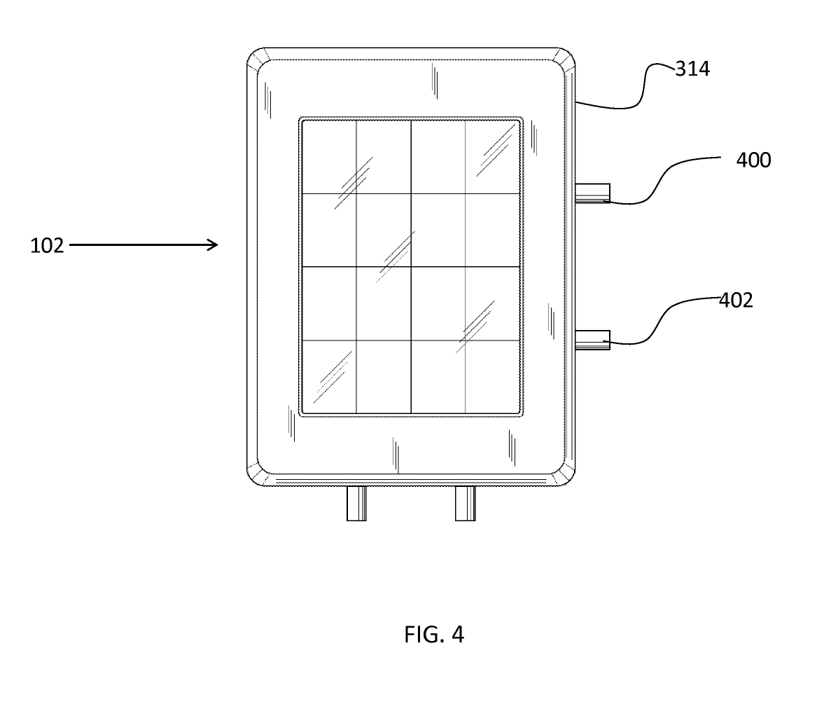

Referring now primarily to FIG. 3 and FIG. 4, the solar-cell 108 is electronically coupled to a terminal 400. The terminal 400 can be an entry point and/or a departure point for electrical current traveling with a system of solar-cell pavers 100. FIG. 4 depicts at least two terminals 400, 402, disposed around the periphery 314 of the paver body 102. In one embodiment, one of the two terminals 400, 402 is operable as a negative terminal and a second of the two terminal 400, 402 is operable as a positive terminal. In one embodiment, the solar-cell 108 is electronically coupled to the terminal 400 through a wiring system. In one embodiment, the wiring system may be made of cable, or other electrically conductive material. In another embodiment, the wiring system may be made of copper, as would be appreciated by one of ordinary skill in the art. In one embodiment, the wiring system may be wired to a battery, or other power storage facility. The battery may be operable to fully charge during the day when the solar-cell 108 is exposed to sunlight. In some embodiments, the terminal 400 can be formed as a male-type terminal. In other embodiments, the terminal 400 can be formed as a female-type terminal, configured to mate with the male-type terminal.

In order to collect and transfer solar energy, as sunlight penetrates the solar-cell 108, the sunlight's photons create a negatively charged electron and a positively charged ion, i.e., a “hole.” The negative electrons and positive ions drift toward opposite terminals of the solar-cell 108 creating a voltage difference in the solar-cell 108. When a load is electrically coupled to the terminals, electron current flows towards the positively charged holes and useful electrical power becomes available at the load.

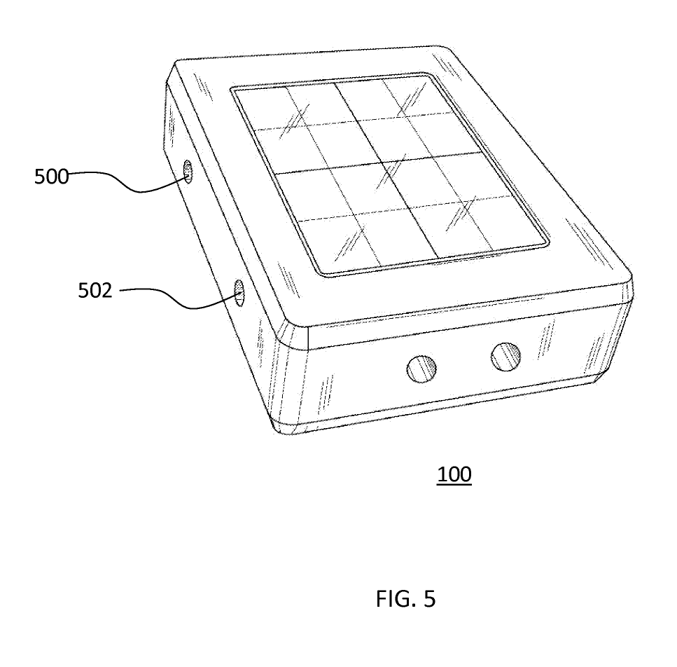

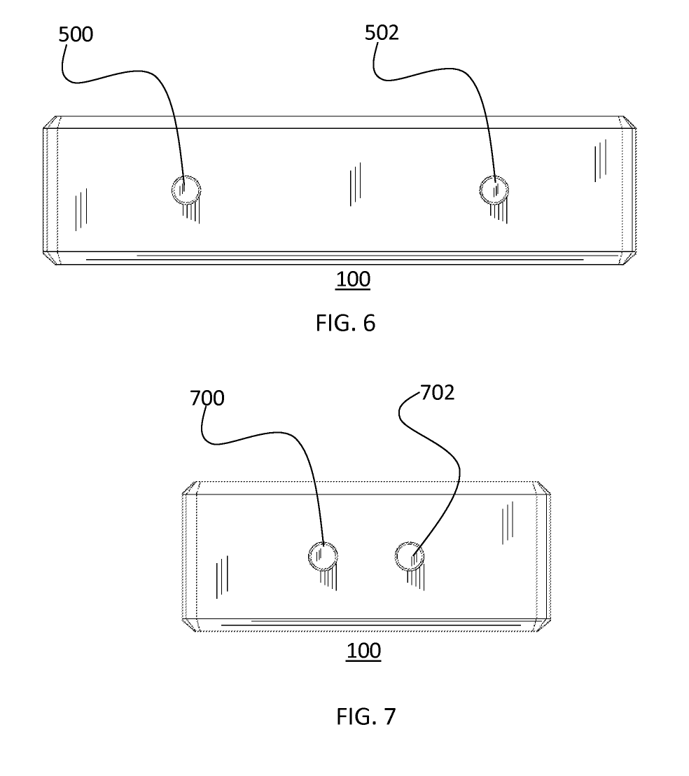

With reference now to FIG. 4 and FIG. 5, the terminals 400, 402, are shaped to fixedly mate and lock with one another. In one exemplary embodiment, the terminals 400, 402 are shaped to fixedly mate and lock with the terminals 500, 502 (FIG. 5) of an adjacent solar-cell paver 100. In one embodiment, the terminals 400, 402 may fixedly mate and lock with one another using a tongue-and-groove locking system. In another embodiment the terminals 400, 402 may be male terminals, while the terminals 500, 502 may be female terminals shaped to receive the male terminals 400, 402. In one embodiment, the electrical contact grid 324 (FIG. 3) may extend to the terminals 400, 402, 500, 502 such that the electrical contact grid 324 of one solar-cell paver 100 can mechanically and electrically couple with adjacent solar-cell pavers 100 via corresponding mating terminals 400, 402, 500, 502. The tongue-and-groove locking system can provide a mechanical coupling of adjacent solar-cell pavers 100, while the configuration of the electrical contact grid 324 extending toward the terminals 400, 402, 500, 502 can provide the electrical coupling of adjacent solar-cells 108. FIG. 6 depicts a side elevation view of the terminals 500, 502. FIG. 7 depicts a rear elevation view of a pair of terminals 700, 702 designed to mate with a pair of terminals on the front of an adjacent solar-cell paver 100. The terminals 400, 402, 500, 502, 700, 702, may be arranged in other positions and may correspond to other charges, as predetermined by an engineer when designing the roadway 804 (FIG. 8), or another surface, such as a sidewalk or similar pathway.

With reference now to FIG. 8 and FIG. 9, one embodiment of the solar-cell paving system 800 is shown. The solar-cell paving system 800 is designed to collect solar energy from a plurality of solar-cell pavers 100 forming a support surface and transfer usable energy to an energy storage facility. Advantageously, the solar-cell paving system 800 is designed to reduce utility costs and provide a reliable source of electricity. In addition, the use of the solar energy eliminates the need to purchase expensive fossil fuel to generate electricity.

The solar-cell paving system 800 includes the plurality of solar-cell pavers 100a-n joined together in an electrical network 910 to form the continuous driving surface 802 of the roadway 804. The number of solar-cell pavers from “a” to “n” can be any number. Naturally, the number of solar-cell pavers 100 forming the roadway 804 can vary, according to the overall dimensions of the solar-cell pavers 100 and the length and the width of the roadway 804. In one example, the roadway 804 may be designed for use within a rural area. In another embodiment, the roadway 804 may be designed for use as a highway. The term “continuous” is defined herein as uninterrupted in sequence, i.e., no other standard pavers are used within the system 800. More specifically, each solar-cell paver 100 is joined directly to another solar-cell paver 100, with no other standard pavers, i.e., pavers without solar-cells 108, between any of the solar-cell pavers 100.

In one embodiment, the solar-cell pavers 100, more specifically the terminals 400, 402, 500, 502 are matingly joined together to form the electrical network 910. In one embodiment, an array of solar-cell pavers 100 is formed, with columns of solar-cell pavers 100 arranged to be parallel with one another. FIG. 9 depicts a portion of the electrical network 910 formed by joining together a plurality of solar-cell pavers 100a-n. The electrical network 910 is designed to achieve useful levels of voltage and current. The electrical network 910 includes the wiring components necessary to connect the solar-cell pavers 100 together to form the electrical network 910. In some embodiments, the solar-cell pavers 100 are electrically coupled together in parallel circuits. In other embodiments, the solar-cell pavers 100 are electrically coupled together in series. In an alternative embodiment, the solar-cell pavers 100 may be electrically coupled in a combination of series and parallel circuits, as commonly known by those of ordinary skill in the art.

The respective height of each of the solar-cell pavers 100 is identical so that the continuous driving surface 802 is substantially planar. As previously stated, the term “substantially planar” is defined herein as a generally flat, or level surface. Advantageously, vehicles, pedestrians, bicycles, and the like can travel over the roadway 804 without experiencing a hazardous uneven surface. The roadway 804 is intended mainly for use by traveling motor vehicles, however the roadway 804 may also be used by pedestrians, bicycles, and any other mechanism capable of traveling over a standard roadway.

The solar-cell pavers 100 may be joined together within a new structure or a pre-existing structure. In order to join the solar-cell pavers 100 together in a new structure, i.e., to form a new roadway 804, in one embodiment, the solar-cell pavers 100 are placed within a channel 906 defined by a compact surface 908. The term “compact surface,” as used herein, is intended to indicate a surface made of closely packed materials, forming a firm support structure. In one embodiment, the compact surface 908 is a tightly packed ground surface material, such as clay, that has been evenly compacted and leveled. In another embodiment, the compact surface 908 includes a layer of base material and a layer of sand. In yet another embodiment, the compact surface 908 includes a layer of clay and sand. In other embodiments, the compact surface 908 may be another type of ground material. In one embodiment, the ground material is operable to absorb fluid, particularly rain water and oil. In order to join the solar-cell pavers 100 together in a pre-existing structure, a section of an existing roadway may be removed and the solar-cell pavers 100 may be inserted within the vacant section to form a continuous driving surface 802 of the roadway 804.

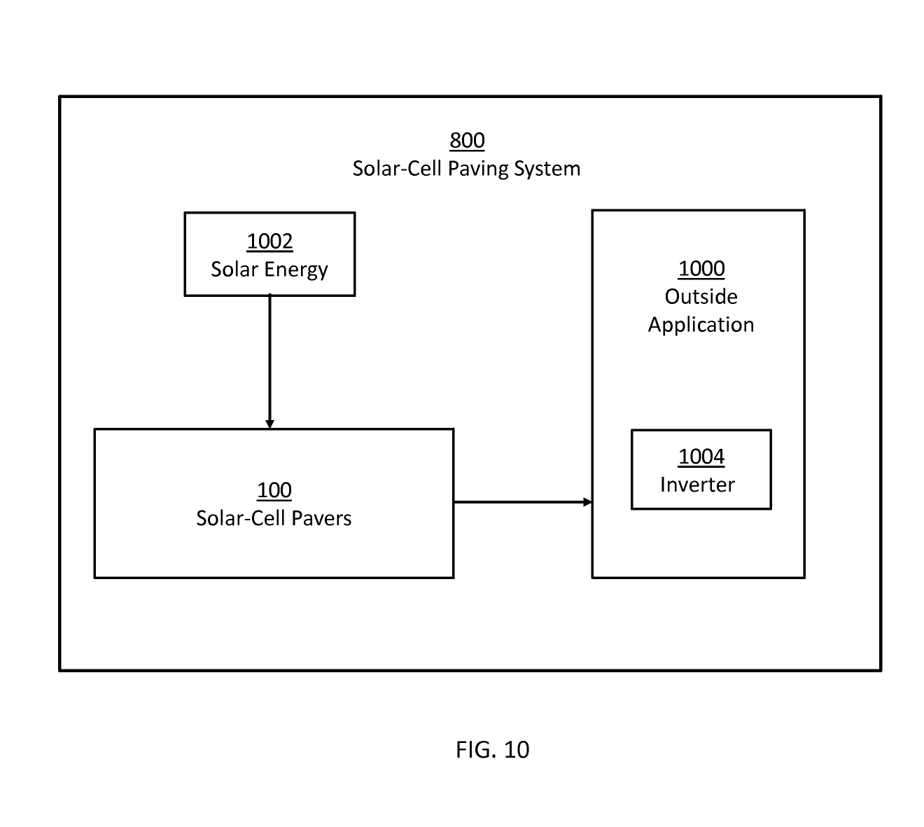

FIG. 10 provides an overview of an embodiment of the solar-cell paving system 800 having at least one outside application 1000. The solar-cell paving system 800 is designed to collect and transfer a quantity of solar energy 1002 to the outside application 1000. As used herein, the term “outside application” is intended to indicate a load, a plurality of loads housed within a structure, an energy grid, or other energy storage facility that is physically separate from the plurality of solar-cell pavers 100, yet electrically coupled to the plurality of solar-cell pavers 100. In one embodiment, the outside application 1000 is physically remote from the plurality of solar-cell pavers 100, yet in relatively close proximity. In another embodiment, the outside application 1000 is located a substantial distance from the plurality of solar-cell pavers 100. In one embodiment, the outside application 1000 is a structure located in close proximity to the pavers 100. More specifically, the outside application 1000 may be a home, a business, or the like. In another embodiment, the outside application 1000 may be an electronic appliance. In yet another embodiment, the outside application 1000 may be an energy grid. Advantageously, the energy grid allows a user to purchase electricity when needed and allows a user to sell electricity back to the energy grid when the user produces more electricity than needed. The outside application 1000 is depicted in FIG. 10 having an inverter 1004. The inverter 1004 is a device that is operable to convert direct current generated by the solar-cell paving system 800 into alternating current for use within the building or the energy grid.

Referring now to the FIG. 8 and FIG. 9 in conjunction with the process flow diagram of FIG. 11, there is provided a method of installing a solar-cell paver 100 to form the roadway 804. The process flow diagram of FIG. 11 begins at step 1100 and proceeds directly to step 1102, where the compact surface 908 is provided. The compact surface 908 may be pre-selected by an architect, or engineer when designing the roadway 804. In one embodiment, the compact surface 908 is operably configured to be able to support a weight of the plurality of solar-cell pavers 100 and the weight of moving traffic, such as pedestrians, bicycles, and, in some embodiments, motor vehicles, over a prolonged period of time.

In step 1104, the process continues by constructing at least one channel 906 in the compact surface 908. Preferably, the channel 906 includes a vertical height that is deep enough to securely place the solar-cell pavers 100 within the channel 906. The compact surface and/or channel may also be graded accordingly to determine the slope of the ground surface to which the paver will be mounted—and perhaps formed to its specification. Naturally, the vertical height of the channel 906 may vary, according to the vertical height of the solar-cell pavers 100. In step 1106 the plurality of solar-cell pavers 100 are provided within the channel 906. The number of solar-cell pavers 100 varies, depending on the length and the width of the roadway 804. In one embodiment, the plurality of solar-cell pavers 100 is formed as an array of solar-cell pavers 100. The material of the compact surface 908 is operable to hold the pavers in a stationary position, even as external forces are applied to it by moving traffic. In one embodiment, once the solar-cell pavers 100 are provided within the channel, a compactor is used over the solar-cell pavers 100 to assist in securing the solar-cell pavers 100 together within the channel 906 of the compact surface 908.

In step 1108, the solar-cell pavers 100 are joined together in the electrical network 910 to form the continuous driving surface 802 of the roadway 804. The electrical network 910 can be formed as an electrical coupling of each of the solar-cell pavers 100. The solar-cell pavers 100 can be electrically coupled in series, in parallel, and/or a combination of parallel and series circuits. The process ends at step 1110.

Although FIG. 11 show a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 11 for the sake of brevity.

A solar-cell paver, a solar-cell paving system, and a method of installing a plurality of solar cell pavers has been disclosed that features a solar-cell paver including a light transmitting member and a permeable material, which allows a solar-cell to harness solar energy, while permitting fluid to pass through the permeable material, eliminating the need for additional potentially hazardous drainage crates and preventing fluid from accumulating around the solar-cell pavers causing misalignment. Other features of the invention have been disclosed that add to the ability of the solar-cell paver to efficiently and conservatively collect the radiant energy of sunlight and convert the radiant energy into usable energy, but are not intended to be limited to the particular details disclosed herein.

What is claimed is:

1. A solar-cell paver comprising:
a paver body:
having an upper surface, an opposing lower surface opposite the upper surface, and a thickness separating the upper and lower surfaces;
defining a cavity within the paver body, the cavity enclosing at least one solar-cell disposed therein and electronically coupled to at least one terminal; and
of a permeable material spanning the thickness of the paver body; and
a light transmitting member disposed above the at least one solar-cell, the light transmitting member coupled to the paver body in a watertight configuration and of a transparent material defining a portion of the upper surface.

2. The solar-cell paver according to claim 1, wherein:
the permeable material is of a ground tire rubber constituent.

3. The solar-cell paver according to claim 1, wherein:
the upper surface is substantially planar.

4. The solar-cell paver according to claim 1, wherein:
the permeable material substantially surrounds a periphery of the light transmitting member.

5. The solar-cell paver according to claim 1, further comprising:
a watertight liner interposed between the at least one solar-cell and the permeable material of the paver body.

6. The solar-cell paver according to claim 5, wherein:
the watertight liner is of a shape defined by the cavity.

7. The solar-cell paver according to claim 1, wherein:
the paver body is of a uniform thickness.

8. The solar-cell paver according to claim 1, further comprising:
at least two terminals disposed around a periphery of the paver body, one of the least two terminals operable as a negative and a second of the least two terminals operable as a positive.

9. The solar-cell paver according to claim 1, further comprising:
at least two terminals disposed around a periphery of the paver body, the at least two terminals shaped to fixedly mate and lock with one another.

10. The solar-cell paver according to claim 1, wherein the light transmitting member further comprises:
an impermeable resilient material.

11. The solar-cell paver according to claim 1, wherein the light transmitting member further comprises:
an upper surface with a periphery flanked by the upper surface of the paver body to form
an upper surface partition separating the light transmitting member and a periphery of the paver body, the upper surface partition of the permeable material.

12. The solar-cell paver according to claim 11, wherein:
the upper surface partition has a substantially uniform width.

13. The solar-cell paver according to claim 12, wherein
the substantially uniform width is at least 4 inches.

14. A solar-cell paving system to collect and transfer solar energy comprising:
a plurality of pavers joined together in an electrical network to form a continuous driving surface of a roadway, the plurality of pavers including:
a paver body:
having an upper surface, an opposing lower surface opposite the upper surface, and a thickness separating the upper and lower surfaces;
defining a cavity within the paver body, the cavity enclosing at least one solar-cell disposed therein and electronically coupled to at least one terminal; and
of a permeable material spanning the thickness of the paver body; and
a light transmitting member coupled to the paver body in a watertight configuration and of a transparent material defining a portion of the upper surface.

15. The solar-cell paving system to collect and transfer solar energy according to claim 14, wherein:
the continuous driving surface of the roadway is substantially planar.

16. The solar-cell paving system to collect and transfer solar energy according to claim 14, wherein the paver body further comprises:
at least two terminals disposed around a periphery of the paver body, one of the at least two terminals operable as a negative and a second of the at least two terminals operable as a positive.

17. The solar-cell paving system to collect and transfer solar energy according to claim 16, wherein:
the plurality of pavers are joined together in an array.

18. The solar-cell paving system to collect and transfer solar energy according to claim 14, wherein the light transmitting member further comprises:
an upper surface with a periphery flush with the upper surface of the paver body to form an upper surface partition separating the light transmitting member and a periphery of the paver body, the upper surface partition of the permeable material.

19. The solar-cell paving system to collect and transfer solar energy according to claim 14, further comprising:
at least one outside application, the at least one outside application operable to receive a quantity of electrical energy from the plurality of pavers.

20. A method of installing a plurality of solar-cell pavers, the method comprising:
providing a compact surface;
constructing at least one channel in the compact surface;
providing a plurality of solar-cell pavers within the at least one channel, the solar-cell pavers including:
a paver body, the paver body having an upper surface, an opposing lower surface opposite the upper surface, and a thickness separating the upper and lower surfaces, the paver body defining a cavity within the paver body, the cavity enclosing at least one solar-cell disposed therein and electronically coupled to at least one terminal, the paver body of a permeable material spanning the thickness of the paver body and a light transmitting member disposed above the at least one solar-cell, the light transmitting member coupled to the paver body in a watertight configuration and of a transparent material defining a portion of the upper surface; and
joining the plurality of solar-cell pavers together in an electrical network to form a continuous driving surface of a roadway.
